(19) United States
(12) Patent Application Publication
(10) Pub. No.: US 2012/0278528 A1
(43) Pub. Date: Nov. 1, 2012

(54) IIMPLEMENTING STORAGE ADAPTER WITH ENHANCED FLASH BACKED DRAM MANAGEMENT

(75) Inventors: Robert E. Galbraith, Rochester, MN (US); Murali N. Iyer, Rochester, MN (US); Timothy J. Larson, LaCrosse, WI (US); Steven P. Norgaard, Rochester, MN (US)

(73) Assignee: INTERNATIONAL BUSINESS MACHINES CORPORATION, Armonk, NY (US)

(21) Appl. No.: 13/096,222

(22) Filed: Apr. 28, 2011

(51) Int. Cl. G06F 12/02

(52) U.S. Cl. 711/103; 711/E12.008

(57) ABSTRACT

A method and controller for implementing enhanced flash backed dynamic random access memory (DRAM) management, and a design structure on which the subject controller circuit resides are provided. An input/output adapter (IOA) includes at least one super capacitor, a data store (DS) dynamic random access memory (DRAM), a flash memory, a non-volatile random access memory (NVRAM), and a flash backed DRAM controller. Responsive to an adapter reset, Data Store DRAM testing including restoring a DRAM image from Flash to DRAM and testing of DRAM is performed. Mirroring of RAID configuration data and RAID parity update footprints between the NVRAM and DRAM is performed. Save of DRAM contents to the flash memory is controllably enabled when super capacitors have been sufficiently recharged and the flash memory erased.

### FIELD OF THE INVENTION

The present invention relates generally to the data processing field, and more particularly, relates to a method and controller for implementing enhanced flash backed dynamic random access memory (DRAM) management, and a design structure on which the subject controller circuit resides.

### DESCRIPTION OF THE RELATED ART

Storage adapters are used to connect a host computer system to peripheral storage I/O devices such as hard disk drives, solid state drives, tape drives, compact disk drives, and the like. Currently various high speed system interconnects are to connect the host computer system to the storage adapter and to connect the storage adapter to the storage I/O devices, such as, Peripheral Component Interconnect Express (PCIe), Serial Attach SCSI (SAS), Fibre Channel, and InfiniBand.

For many years, hard disk drives (HDDs) or spinning drives have been the dominant storage I/O device used for the persistent storage of computer data which requires online access. Recently, solid state drives (SSDs) have become more popular due to their superior performance. Specifically, SSDs are typically capable of performing more I/Os per seconds (IOPS) than HDDs, even if their maximum data rates are not always higher than HDDs.

Storage adapters often contain a write cache to enhance performance. The write cache is typically non-volatile and is used to mask a write penalty introduced by redundant array of inexpensive drives (RAID), such as RAID-5 and RAID-6. A write cache can also improve performance by coalescing multiple host operations (ops) placed in the write cache into a single destage op which is then processed by the RAID layer and disk devices.

Storage adapters also use non-volatile memory to store parity update footprints which track the parity stripes, or portions of the parity stripes, which potentially have the data and parity out of synchronization.

Data and parity are temporarily placed out of synchronization each time new data is written to a single disk in a RAID array. If the adapter fails and loses the parity update footprints then it is possible that data and parity could be left out of synchronization and the system could be corrupted if later the parity is used to recreate data for the system.

The non-volatile memory used for write cache data/directory and parity update footprints has typically taken the following forms:

1. Battery-backed DRAM memory (i.e. a rechargeable battery such as NiCd, NiMh, or Li Ion);
2. Battery-backed SRAM memory (i.e. a non-rechargeable battery such as a Lithium primary cell); and
3. Flash-backed SRAM memory (i.e. using a small capacitor to power the save of SRAM contents of SRAM to Flash, without external involvement).

Only the battery-backed DRAM memory provides for a sufficiently large memory, for example, GBs of DRAM, which is required by a write cache, thus requiring the complexity and maintenance issues of a rechargeable battery. Also, many robust storage adapter designs use a combination of non-volatile memories, such as the battery-backed DRAM memory or the Flash-backed SRAM memory, to provide for greater redundancy and design flexibility. For example, it is desirable for a robust storage adapter design to store parity updated footprints as well as other RAID configuration information in more than a single non-volatile memory.

A new flash-backed DRAM memory technology is available which is capable of replacing the battery-backed DRAM memory. This technology uses a super capacitor to provide enough energy to store the DRAM contents to flash memory when a power-off condition occurs.

However, the flash-backed DRAM memory technology must be managed differently than conventional battery-backed DRAM memory. The battery-backed DRAM memory could save the current contents of DRAM many times over in a short period of time. The DRAM memory could simply be placed into and removed from a self-refresh mode of operation to save the current contents of DRAM.

The flash-backed DRAM memory technology can only be saved when both super capacitors have been sufficiently recharged and the flash memory erased. Thus, prior art storage adapters are not effective for use with the flash-backed DRAM memory technology.

A need exists for a method and controller for implementing enhanced flash backed dynamic random access memory (DRAM) management. New methods and policies for management of this non-volatile memory are required. It is desirable to use a combination of flash-backed DRAM memory and flash-backed SRAM memory. Additional new methods and policies are required in order to be able to mirror data contents between these two different technologies.

### SUMMARY OF THE INVENTION

Principal aspects of the present invention are to provide a method and controller for implementing enhanced flash backed dynamic random access memory (DRAM) management, and a design structure on which the subject controller circuit resides. Other important aspects of the present invention are to provide such method, controller, and design structure substantially without negative effects and that overcome many of the disadvantages of prior art arrangements.

In brief, a method and controller for implementing enhanced flash backed dynamic random access memory (DRAM) management in a data storage system, and a design structure on which the subject controller circuit resides are provided. The data storage system includes input/output adapter (IOA) including at least one super capacitor, a data store (DS) dynamic random access memory (DRAM), a flash memory, a non-volatile random access memory (NVRAM), and a flash backed DRAM controller. Responsive to an adapter reset, DRAM testing including restoring a DRAM image from Flash to DRAM and testing of DRAM is performed. Mirroring of RAID configuration data and RAID parity update footprints between the NVRAM and DRAM is performed. Save of DRAM contents to the flash memory is controllably enabled when the super capacitor has been sufficiently recharged and the flash memory erased.

In accordance with features of the invention, DRAM testing includes checking for a save or restore currently in progress. Responsive to identifying a save or restore currently in progress, a delay is provided to wait for change. When the DRAM has not previously initialized, checking if a saved flash backed DRAM image exists is performed. After restoring the saved flash backed image to the DRAM when available, and when the DRAM has been previously initialized, non-destructive DRAM testing is performed. After a normal power down of the adapter where no contents of the DRAM need to be saved and thus the save was disabled and a saved flash backed DRAM image does not exist, no restore is needed. Responsive to unsuccessful non-destructive DRAM testing, destructive DRAM testing is performed. The DRAM is tested and zeroed by destructive DRAM testing.

In accordance with features of the invention, mirroring of RAID configuration data and RAID parity update footprints between the NVRAM and DRAM includes merging flash-backed DRAM and flash-backed SRAM contents. The merging process maintains the latest RAID parity update footprints in NVRAM while also maintaining the write cache data/directory contents of the restored DRAM. Mirror synchronization of the DRAM and NVRAM is restored prior to allowing new data to be placed in the write cache.

In accordance with features of the invention, save of DRAM contents to the flash memory includes checking for an existing flash image, and releasing a saved flash image. Checking hardware state including the state of super capacitors is performed before enabling save of data from DRAM to the flash memory on power off.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a schematic and block diagram illustrating an exemplary system for implementing enhanced flash backed dynamic random access memory (DRAM) management in accordance with the preferred embodiment;

FIG. 2 illustrate exemplary contents of a flash backed DRAM and a non-volatile random access memory (NVRAM) in accordance with the preferred embodiment;

FIGS. 3, 4, 5, and 6 are flow charts illustrating exemplary operations performed by the flash backed DRAM controller for implementing enhanced flash backed DRAM management in accordance with the preferred embodiment; and

FIG. 7 is a flow diagram of a design process used in semiconductor design, manufacturing, and/or test.

### DETAILED DESCRIPTION OF THE PREFERRED EMBODIMENTS

In the following detailed description of embodiments of the invention, reference is made to the accompanying drawings, which illustrate example embodiments by which the invention may be practiced. It is to be understood that other embodiments may be utilized and structural changes may be made without departing from the scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In accordance with features of the invention, a method and controller implement enhanced flash backed dynamic random access memory (DRAM) management, and a design structure on which the subject controller circuit resides is provided.

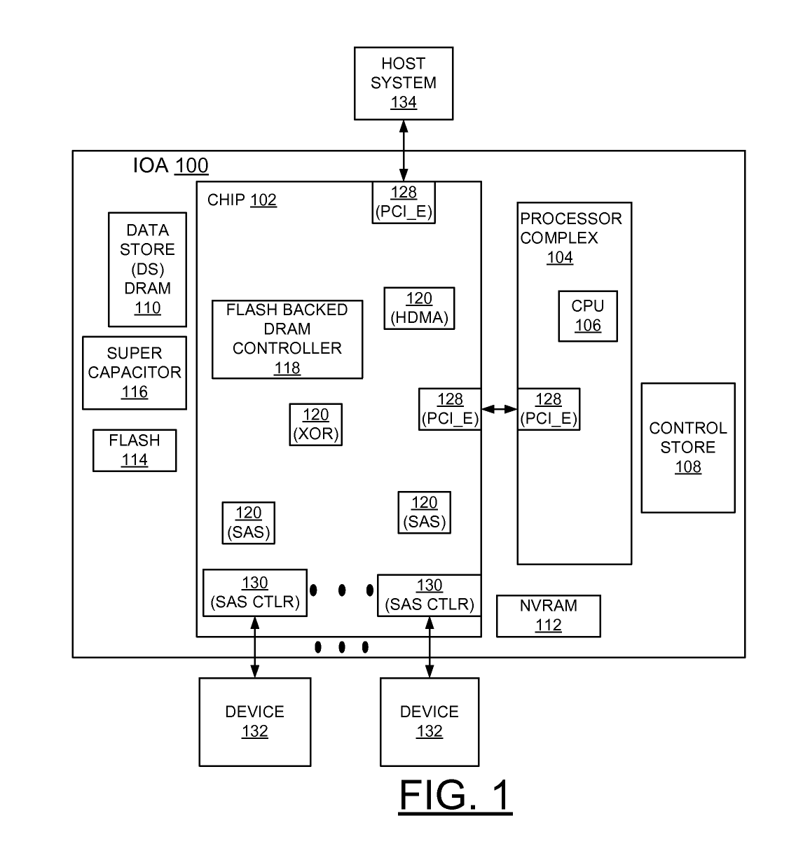

Having reference now to the drawings, in FIG. 1, there is shown an input/output adapter (IOA) or storage adapter in accordance with the preferred embodiment generally designated by the reference character 100. Storage adapter 100 includes a semiconductor chip 102 coupled to a processor complex 104 including a central processor unit (CPU) 106. Storage adapter 100 includes a control store (CS) 108, such as a dynamic random access memory (DRAM) proximate to the CPU 106 providing control storage and a data store (DS) DRAM 110 providing write cache data storage. Storage adapter 100 includes a non-volatile random access memory (NVRAM) 112, a flash memory 114, and one or more super capacitors 116 providing enough energy to store the DRAM contents to flash memory when a power-off condition occurs.

Storage adapter 100 includes a flash backed DRAM controller 118 for implementing enhanced flash backed dynamic random access memory (DRAM) management in accordance with the preferred embodiment. Semiconductor chip 102 includes a plurality of hardware engines 120, such as, a hardware direct memory access (HDMA) engine 120, an XOR or sum of products (SOP) engine 120, and a Serial Attach SCSI (SAS) engine 120. Semiconductor chip 102 includes a respective Peripheral Component Interconnect Express (PCIe) interface 128 with a PCIe high speed system interconnect between the controller semiconductor chip 102 and the processor complex 104, and a Serial Attach SCSI (SAS) controller 130 with a SAS high speed system interconnect between the controller semiconductor chip 102 and each of a plurality of storage devices 132, such as hard disk drives (HDDs) or spinning drives 132, and solid state drives (SSDs) 132. As shown host system 134 is connected to the controller 100, for example, with a PCIe high speed system interconnect.

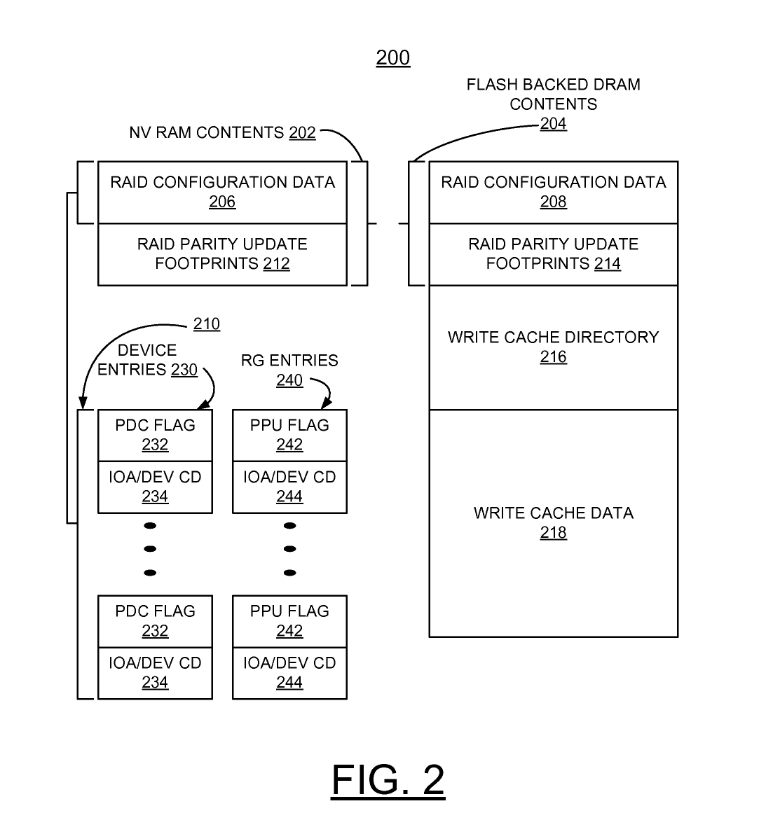

Referring to FIG. 2, there are shown exemplary flash backed DRAM and a non-volatile random access memory (NVRAM) contents generally designated by the reference character 200 in accordance with the preferred embodiment. The flash backed DRAM and NVRAM contents 200 include NVRAM contents generally designated by the reference character 202 stored in NVRAM 112 and flash backed DRAM contents generally designated by the reference character 204 stored in DS DRAM 110. Keeping two copies in NVRAM contents 202 and the flash backed DRAM contents 204 is provided to avoid a single point of failure.

NVRAM contents 202 include redundant array of inexpensive drives (RAID) configuration data 206, and the flash backed DRAM contents 204 include corresponding RAID configuration data 208. As shown, the RAID configuration data 206 includes RAID device and redundancy group (RG) entries generally designated by the reference character 210 and are additionally stored in the storage devices 132. NVRAM contents 202 include RAID parity update footprints 212, and the flash backed DRAM contents 204 include corresponding RAID parity update footprints 214.

The flash backed DRAM contents 204 include a write cache directory 216 and write cache data 218. The DS DRAM is implemented, for example, with 8 GB of DRAM.

The RAID device and redundancy group (RG) entries 210, stored in RAID configuration data 206 and corresponding RAID configuration data 208, includes device entries generally designated by the reference character 230 and redundancy group entries generally designated by the reference character 240.

The device entries 230 include a flag indicating possible data in cache (PDC) flag 232 and an IOA/Dev correlation data (CD) 234, respectively stored in the storage devices 132. The RG entries 240 include a flag indicating possible parity update (PPU) flag 242 and an IOA/RG correlation data (CD) 244, respectively stored in the storage devices 132. When the PDC flag 232 is on, then there are potentially valid write cache contents in the write cache directory 216 and write cache data 218 on the respective device. Otherwise, if the PDC flag 232 is off, then there are no valid write cache contents for the device. When the PPU flag 242 is on, then there are potentially valid entries in the RAID parity update footprints 212, 214 for the respective redundancy group. Otherwise, if the PPU flag 242 is off, then there are no valid entries for the respective redundancy group.

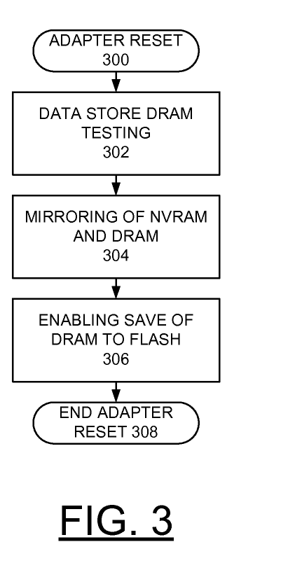

Referring to FIGS. 3, 4, 5, and 6 there are shown flow charts illustrating exemplary operations performed by the flash backed DRAM controller 118 for implementing enhanced flash backed DRAM management in accordance with the preferred embodiment.

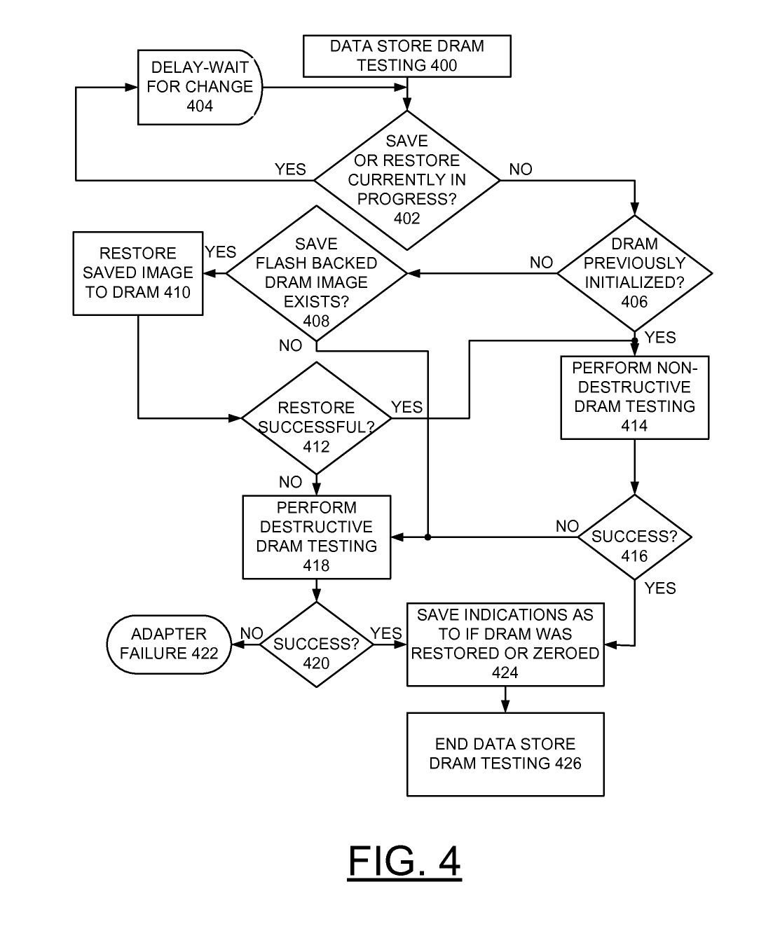

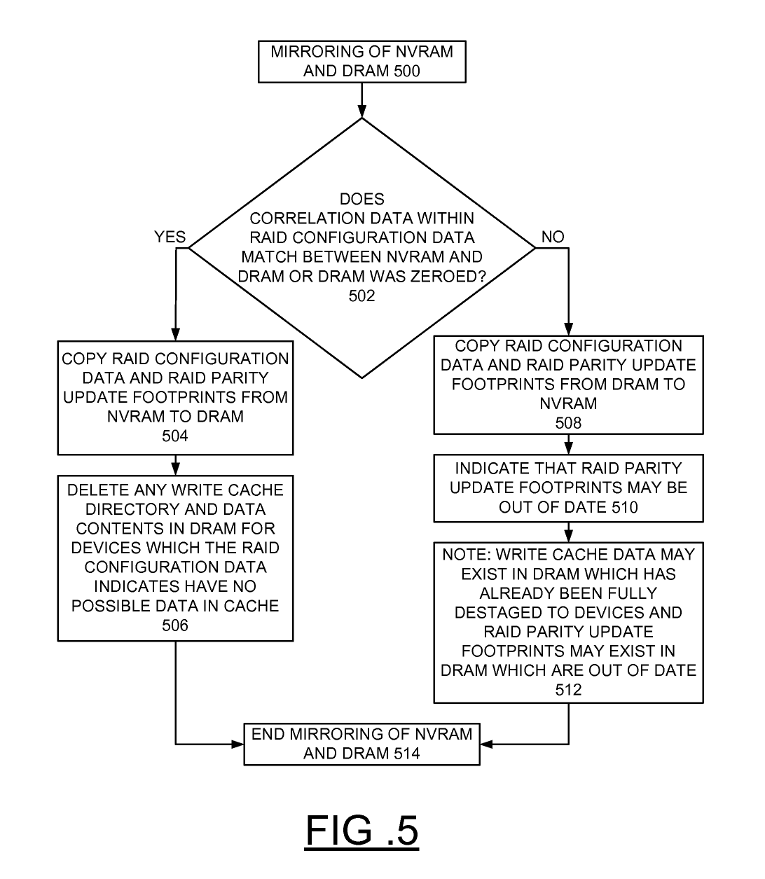

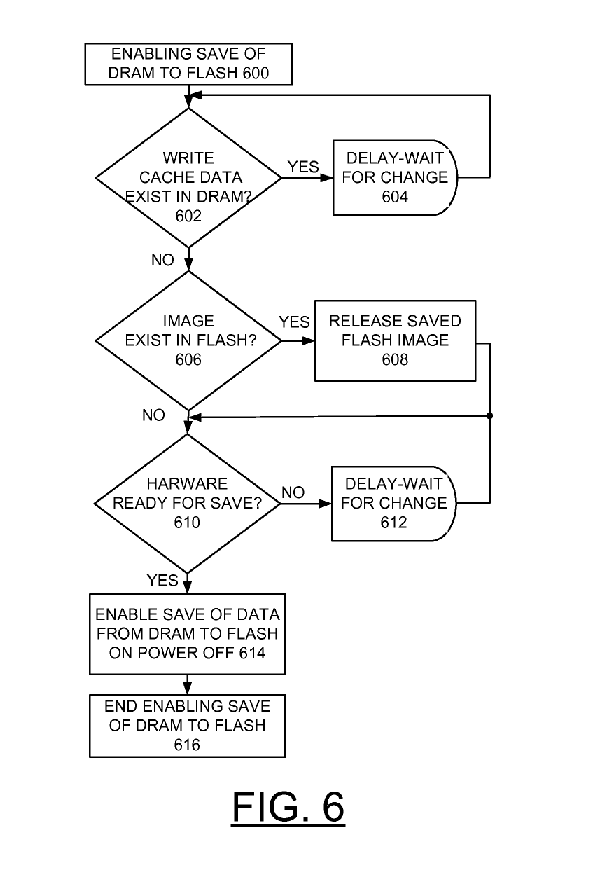

Referring to FIG. 3, the operations begin as indicated at a block 300 responsive to an adapter reset. As indicated at a block 302 DRAM testing is performed, including restoring a DRAM image from Flash to DRAM and testing of DRAM as illustrated and described with respect to FIG. 4. As indicated at a block 304, mirroring of RAID configuration data and RAID parity update footprints between the NVRAM and DRAM is performed as illustrated and described with respect to FIG. 5. Save of DRAM contents to the flash memory is controllably enabled as indicated at a block 306. As illustrated and described with respect to FIG. 6, save of DRAM contents to the flash memory is only enabled when the super capacitor 118 has been sufficiently recharged and the flash memory 114 has been erased. The operations end as indicated at a block 308.

In accordance with features of the invention, DRAM testing involves restoring a DRAM image from flash memory 114 to DRAM and testing of DRAM 110. This method addresses not only the cases where no image to restore exists and where a successful restore of an image is done, but also handles when a Save or Restore is already in progress, for example, having been started prior to the adapter being reset, and when the restore of an image is unsuccessful.

Referring to FIG. 4, DRAM testing begins as indicated at a block 400. As indicated at a decision block 402 checking for a save or restore currently in progress is performed. Responsive to identifying a save or restore currently in progress, a delay is provided to wait for change as indicated at a block 404. Then as indicated at a decision block 406, checking if the DRAM has been previously initialized is performed. When the DRAM has not previously initialized, checking if a saved flash backed DRAM image exists is performed as indicated at a decision block 408. After a normal power down of the adapter 100 where no contents of the DRAM need to be saved and thus the save was disabled and a saved flash backed DRAM image does not exist, no restore is needed.

An existing saved flash backed DRAM image is restored to the DRAM as indicated at a block 410. Checking whether the restore was successful is performed as indicated at a decision block 412. After successfully restoring the saved flash backed image to the DRAM when available, and when the DRAM has been previously initialized, non-destructive DRAM testing is performed as indicated at a block 414. Checking whether the non-destructive DRAM testing was successful is performed as indicated at a decision block 416. Responsive to unsuccessful non-destructive DRAM testing, destructive DRAM testing is performed as indicated at a block 418. The DRAM is tested and zeroed by destructive DRAM testing at block 418.

Checking whether the destructive DRAM testing was successful is performed as indicated at a decision block 420. Responsive to unsuccessful destructive DRAM testing, adapter failure is identified as indicated at a block 422. Responsive to successful non-destructive DRAM testing or successful destructive DRAM testing, indications as to the DRAM being restored or zeroed are saved as indicated at a block 424. The DS DRAM testing operations end as indicated at a block 428.

In accordance with features of the invention, mirroring of NVRAM 112 and DRAM 110 involves merging flash-backed DRAM contents 204 and flash-backed NVRAM or SRAM contents 202. This method addresses scenarios such as the following: Scenarios after a normal power down of the adapter 100 where no contents of the DRAM 110 need to be saved and thus the Save was disabled, that is where no Restore is needed and the DRAM can be tested and zeroed. Scenarios where an abnormal power down of the adapter 100 results in DRAM 110 being saved to flash memory 114, where upon reset of the adapter 100 the restored DRAM 110 has contents in synchronization with that of the NVRAM 112. Also scenarios similar to above, but where upon reset of the adapter the restored DRAM 110 has contents not in synchronization with that of the NVRAM 112 due to a second power down or reset of the adapter 100 prior to the adapter releasing the flash image, which could occur during the extended period where the adapter works to flush the write cache contents within the DRAM while creating many new RAID parity update footprints in the process.

In accordance with features of the invention, the merging process maintains the latest RAID parity update footprints 212 in NVRAM 112 while also maintaining the write cache data 218 and directory contents 216 of the restored DRAM 110. Mirror synchronization of the contents of DRAM 110 and NVRAM 112 is restored prior to allowing new data to be placed in the write cache.

Referring to FIG. 5, mirroring of RAID configuration data and RAID parity update footprints between the NVRAM and DRAM begins as indicated at a block 500, which includes merging flash-backed DRAM and flash-backed SRAM contents. Checking whether correlation data within RAID configuration data match between NVRAM 112 and DRAM 110, or if the DRAM 110 was zeroed is performed as indicated at a decision block 502. If yes, then the RAID configuration data 206 and the RAID parity update footprints 212 are copied from NVRAM 112 to DRAM 110 as indicated at a block 504. As indicated at a block 506, any write cache directory and data contents in DRAM 110 are deleted for devices which the RAID configuration data 206 in NVRAM 112 indicates no possible data in cache.

Otherwise when the correlation data within RAID configuration data does not match between NVRAM 112 and DRAM 110, and the DRAM 110 was not zeroed, then the RAID configuration data 208 and the RAID parity update footprints 214 are copied from DRAM 110 to NVRAM 112 as indicated at a block 508. Then a flag is set indicating that RAID parity update footprints 214 may be out of date as indicated at a block 510. Next as indicated at a block 512 write cache data may exist in DRAM 110 which has already been fully destaged to devices 132 and RAID parity update footprints 214 may exist in DRAM 110 which are out of date. As indicated at a block 514, mirroring of NVRAM 112 and DRAM 110 ends.

In accordance with features of the invention, enabling of a save of DRAM 110 to flash memory 114 involves releasing any existing DRAM image from flash memory, determining that the hardware is ready to perform another save, for example, that the super capacitor 118 is charged, and enabling a save to occur if a power down should occur. The order of this processing is critical to ensuring that a save of DRAM to flash is both possible and substantially guaranteed to occur should an abnormal power down occur.

Referring to FIG. 6, controllably enabling save of DRAM contents to the flash memory 114 begins as indicated at a block 600. As indicated at a decision block 602, checking whether write cache data exists in DRAM 110 is performed. Responsive to identifying write cache data, a delay is provided to wait for change as indicated at a block 604. As indicated at a decision block 606 checking for an existing flash image is performed, and releasing an identified saved flash image is provided as indicated at a block 608. Checking hardware state as indicated at a decision block 610, including the state of super capacitors being sufficiently charged and enough flash memory being available is performed. Responsive to identifying hardware not ready for save, a delay is provided to wait for change as indicated at a block 612. As indicated at a block 614 save of data from DRAM 110 to the flash memory 114 on power off is enabled. As indicated at a block 616, enabling save of DRAM contents to the flash memory 114 ends.

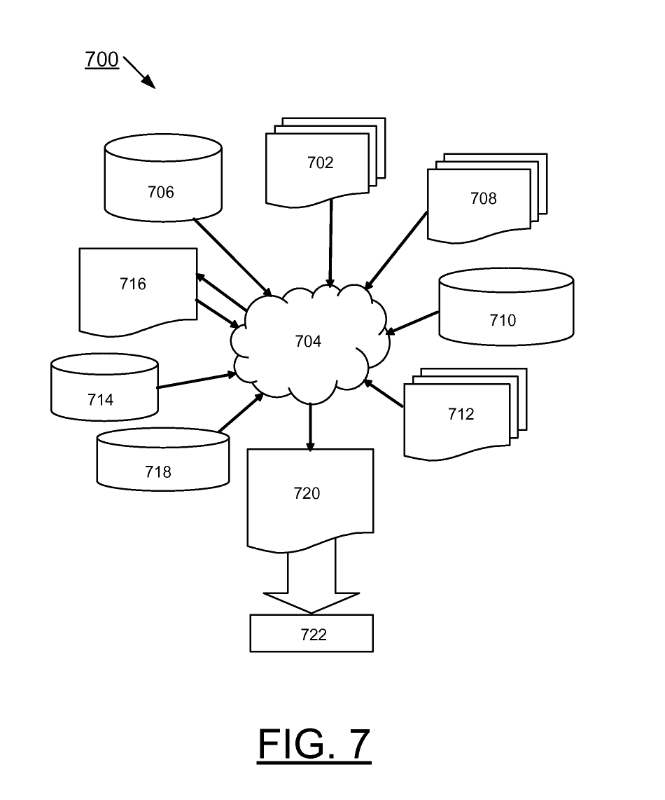

FIG. 7 shows a block diagram of an example design flow 700. Design flow 700 may vary depending on the type of IC being designed. For example, a design flow 700 for building an application specific IC (ASIC) may differ from a design flow 700 for designing a standard component. Design structure 702 is preferably an input to a design process 704 and may come from an IP provider, a core developer, or other design company or may be generated by the operator of the design flow, or from other sources. Design structure 702 comprises circuit 100, and circuit 200 in the form of schematics or HDL, a hardware-description language, for example, Verilog, VHDL, C, and the like. Design structure 702 may be contained on one or more machine readable medium. For example, design structure 702 may be a text file or a graphical representation of circuit 100. Design process 704 preferably synthesizes, or translates, circuit 100, and circuit 200 into a netlist 706, where netlist 706 is, for example, a list of wires, transistors, logic gates, control circuits, I/O, models, etc. that describes the connections to other elements and circuits in an integrated circuit design and recorded on at least one of machine readable medium. This may be an iterative process in which netlist 706 is resynthesized one or more times depending on design specifications and parameters for the circuit.

Design process 704 may include using a variety of inputs; for example, inputs from library elements 708 which may house a set of commonly used elements, circuits, and devices, including models, layouts, and symbolic representations, for a given manufacturing technology, such as different technology nodes, 32 nm, 45 nm, 90 nm, and the like, design specifications 710, characterization data 712, verification data 714, design rules 716, and test data files 718, which may include test patterns and other testing information. Design process 704 may further include, for example, standard circuit design processes such as timing analysis, verification, design rule checking, place and route operations, and the like. One of ordinary skill in the art of integrated circuit design can appreciate the extent of possible electronic design automation tools and applications used in design process 704 without deviating from the scope and spirit of the invention. The design structure of the invention is not limited to any specific design flow.

Design process 704 preferably translates an embodiment of the invention as shown in FIGS. 1, 2, 3, 4, 5, and 6 along with any additional integrated circuit design or data (if applicable), into a second design structure 720. Design structure 720 resides on a storage medium in a data format used for the exchange of layout data of integrated circuits, for example, information stored in a GDSII (GDS2), GL1, OASIS, or any other suitable format for storing such design structures. Design structure 720 may comprise information such as, for example, test data files, design content files, manufacturing data, layout parameters, wires, levels of metal, vias, shapes, data for routing through the manufacturing line, and any other data required by a semiconductor manufacturer to produce an embodiment of the invention as shown in FIGS. 1 2, 3, 4, 5, and 6. Design structure 720 may then proceed to a stage 722 where, for example, design structure 720 proceeds to tape-out, is released to manufacturing, is released to a mask house, is sent to another design house, is sent back to the customer, and the like.

While the present invention has been described with reference to the details of the embodiments of the invention shown in the drawing, these details are not intended to limit the scope of the invention as claimed in the appended claims.

What is claimed is:

1. A data storage system including an input/output adapter (IOA) comprising:
a controller for implementing enhanced flash backed dynamic random access memory (DRAM) management;
a dynamic random access memory (DRAM),
a flash memory,
a non-volatile random access memory (NVRAM),
at least one super capacitor;
said controller responsive to an adapter reset, performing DRAM testing including restoring a DRAM image from flash memory to DRAM and testing of said DRAM; said controller mirroring of RAID configuration data and RAID parity update footprints between the NVRAM and DRAM; and said controller controllably enabling save of DRAM contents to the flash memory responsive to said at least one super capacitor being charged and said flash memory being erased.

2. The data storage system as recited in claim 1 wherein said controller performing DRAM testing includes said controller checking for a save or restore currently in progress; and responsive to identifying a save or restore currently in progress, providing a delay to wait for change.

3. The data storage system as recited in claim 2 wherein said controller performing DRAM testing includes said controller responsive to said DRAM not being previously initialized, checking if a saved flash backed DRAM image exists.

4. The data storage system as recited in claim 3 wherein said controller responsive to restoring the saved flash backed image to said DRAM, and responsive to DS DRAM not being previously initialized, said controller performing non-destructive DRAM testing.

5. The data storage system as recited in claim 1 said controller performing DRAM testing includes said controller performing destructive DRAM testing, responsive to unsuccessful non-destructive DRAM testing.

6. The data storage system as recited in claim 1 wherein said controller mirroring of RAID configuration data and RAID parity update footprints between the NVRAM and DRAM includes merging flash-backed DRAM and flash-backed SRAM contents including maintaining the latest RAID parity update footprints in NVRAM and maintaining the write cache data/directory contents of the restored DRAM.

7. The data storage system as recited in claim 1 wherein said controller controllably enabling save of DRAM contents to the flash memory responsive to said at least one super capacitor being charged and said flash memory being erased includes said controller checking hardware state of said at least one super capacitor, checking for an existing flash image, and releasing an identified saved flash image.

8. A method for implementing enhanced flash backed dynamic random access memory (DRAM) management in data storage system including an input/output adapter (IOA) including a dynamic random access memory (DRAM) controller, said method comprising:
providing a dynamic random access memory (DRAM) with the IOA,
providing a flash memory with the IOA,
providing a non-volatile random access memory (NVRAM) with the IOA,
providing at least one super capacitor with the IOA,
responsive to an adapter reset, performing data store DRAM testing including restoring a DRAM image from flash memory to DRAM and testing of said DRAM;
mirroring of RAID configuration data and RAID parity update footprints between the NVRAM and DRAM; and
controllably enabling save of DRAM contents to said flash memory responsive to said at least one super capacitor being charged and said flash memory being erased.

9. The method as recited in claim 8 wherein performing DRAM testing includes checking for a save or restore currently in progress; and responsive to identifying a save or restore currently in progress, providing a delay to wait for change before testing of said DRAM.

10. The method as recited in claim 9 includes checking if a saved flash backed DRAM image exists responsive to said DRAM not being previously initialized, and restoring a saved flash backed image to said DRAM.

11. The method as recited in claim 10 further includes performing non-destructive DRAM testing responsive to restoring the saved flash backed image to said DRAM, and responsive to said DRAM being previously initialized.

12. The method as recited in claim 8 wherein performing DRAM testing includes performing destructive DRAM testing, responsive to unsuccessful non-destructive DRAM testing.

13. The method as recited in claim 8 wherein mirroring of RAID configuration data and RAID parity update footprints between the NVRAM and DRAM includes merging flash-backed DRAM and flash-backed SRAM contents including maintaining the latest RAID parity update footprints in NVRAM and maintaining the write cache data/directory contents of the restored DRAM.

14. The method as recited in claim 8 wherein controllably enabling save of DRAM contents to the flash memory responsive to said at least one super capacitor being charged and said flash memory being erased includes said controller checking hardware state of said at least one super capacitor, checking for an existing flash image, and releasing an identified saved flash image.

15. A design structure embodied in a machine readable medium used in a design process, the design structure comprising:
a controller circuit tangibly embodied in the machine readable medium used in the design process, said controller circuit for implementing enhanced flash backed dynamic random access memory (DRAM) management in a data storage system, said controller circuit comprising:
a dynamic random access memory (DRAM),
a flash memory,
a non-volatile random access memory (NVRAM),
at least one super capacitor;
said controller circuit responsive to an adapter reset, performing DRAM testing including restoring a DRAM image from flash memory to DRAM and testing of said DRAM; said controller circuit mirroring of RAID configuration data and RAID parity update footprints between the NVRAM and DRAM; and said controller circuit controllably enabling save of DRAM contents to the flash memory responsive to said at least one super capacitor being charged and said flash memory being erased, wherein the design structure, when read and used in the manufacture of a semiconductor chip produces a chip comprising said controller circuit.

16. The design structure of claim 15, wherein the design structure comprises a netlist, which describes said controller circuit.

17. The design structure of claim 15, wherein the design structure resides on storage medium as a data format used for the exchange of layout data of integrated circuits.

18. The design structure of claim 15, wherein the design structure includes at least one of test data files, characterization data, verification data, or design specifications.

19. The design structure of claim 15, wherein said controller responsive to restoring the saved flash backed image to said DRAM, and responsive to DS DRAM not being previously initialized, said controller performing non-destructive DRAM testing, and said controller performing destructive DRAM testing, responsive to unsuccessful non-destructive DRAM testing.

20. The design structure of claim 15, wherein said controller mirroring of RAID configuration data and RAID parity update footprints between the NVRAM and DRAM includes merging flash-backed DRAM and flash-backed SRAM contents including maintaining the latest RAID parity update footprints in NVRAM and maintaining the write cache data/directory contents of the restored DRAM.

21. The design structure of claim 15, wherein said controller controllably enabling save of DRAM contents to the flash memory responsive to said at least one super capacitor being charged and said flash memory being erased includes said controller checking hardware state of said at least one super capacitor, checking for an existing flash image, and releasing an identified saved flash image.
